(19) United States
(12) Patent Application Publication
(10) Pub. No.: US 2020/0308741 A1
(43) Pub. Date: Oct. 1, 2020

(54) THERMAL INSULATION FILLING MATERIAL, PREPARATION METHOD THEREOF, AND THERMAL INSULATION ARTICLE

(71) Applicant: 3M INNOVATIVE PROPERTIES COMPANY, St. Paul, MN (US)

(72) Inventor: Weili Hu, Shanghei (CN)

(21) Appl. No.: 16/954,641

(22) PCT Filed: Dec. 13, 2018
(86) PCT No.: PCT/IB2018/060043

§ 371 Date: Jun. 17, 2020

(30) Foreign Application Priority Data
Dec. 21, 2017 (CN) 201711392900.5

(51) Int. Cl. D04H 1/4391; D04H 1/4291; D04H 1/435; D04H 1/4334; D04H 1/4358; D04H 1/76; B68G 1/00

(52) U.S. Cl. CPC D04H 1/43918; D04H 1/4291; D04H 1/435; B68G 2001/005; D04H 1/4358; D04H 1/76; B68G 1/00; D04H 1/4334

(57) ABSTRACT

The invention provides a thermal insulation filling material, a preparation method thereof, and a thermal insulation article, and belongs to the technical field of thermal insulation filling material. The present invention can at least partially resolve the problems of poor durability in thermal insulation filling materials, such as wash durability, compression resilience, and the like in the prior art. The thermal insulation filling material of the present invention comprises: spherical fiber assemblies composed of elastic fibers preferably having an elastic elongation of from 80 to 300% and an elastic recovery of from 85 to 99%.

### TECHNICAL FIELD

The invention belongs to the technical field of thermal insulation filling materials, and particularly relates to a thermal insulation filling material, a preparation method thereof, and a thermal insulation article.

### BACKGROUND

A thermal insulation filling material is a loose material composed of a large amount of fine fibers which can be filled into clothes, quilts or the like for thermal insulation (e.g., heat preservation). Since the fine fibers of the thermal insulation filling material can relatively move while being pressed, the overall shape of the product can also be changed when being tapped and pressed by the user, resulting in a more conformable fit to the user's body and an improved user experience.

The traditional thermal insulation filling materials mainly employ natural down such as duck down and goose down. The physical structure of the natural down provides the good bulkiness, compression resilience, thermal insulation property and the like thereof. However, natural down has some disadvantages such as limited availability, high cost, poor quality uniformity, being susceptible to mold growth, and being likely to cause allergies. Therefore, various artificial, also known as synthetic, fibers can be used as thermal insulation filling materials to replace the natural down.

However, when the thermal insulation filling materials of artificial fibers and natural down are washed and compressed, the fibers therein are prone to entangle, leading to reduced performances thereof after the thermal insulation filling materials have been washed and compressed. That is, the artificial thermal insulation filling materials in the prior art have the problems of poor durability, such as wash durability, compression resilience, and the like, and therefore cannot meet the requirements.

### SUMMARY

The present invention can at least partially resolve the problems of poor durability in thermal insulation filling materials, such as wash durability, compression resilience, and the like in the prior art.

The technical solution adopted to solve the technical problem of the present invention is a thermal insulation filling material including spherical fiber assemblies composed of elastic fibers.

In one embodiment, the elastic fibers have an elastic elongation of from 80 to 300% and an elastic recovery of from 85 to 99%.

In one embodiment, the elastic fibers have a three-dimensionally crimped structure.

In one embodiment, the number of crimps of the three-dimensionally crimped structure is 8 to 50/25 mm.

In one embodiment, the elastic fibers have a fineness of from 0.5 to 7D.

In one embodiment, the elastic fibers have a length of from 15 to 75 mm.

In one embodiment, the elastic fibers include any one or more of a polyester fiber, a polyolefin fiber, a polyurethane fiber, a polylactic acid fiber, a polyether amide fiber, and a two-component composite fiber.

In one embodiment, the spherical fiber assemblies have a particle size of from 2 to 20 mm.

The technical solution adopted to solve the technical problem of the present invention is a preparation method of the above-mentioned thermal insulation filling material, the method including balling the elastic fibers to form the spherical fiber assemblies.

The technical solution adopted to solve the technical problem of the present invention is a thermal insulation article including a covering body and a thermal insulation filling material. The covering body defines an enclosed internal space. The thermal insulation filling material fills in the enclosed internal space defined by the covering body.

In one embodiment, the covering body is a flexible covering body.

In one embodiment, the thermal insulation article is any one of shoes, hats, clothes, pillows, quilts, mats, and sleeping bags.

The thermal insulation filling material of the present invention mainly includes spherical fiber assemblies, and the spherical fiber assemblies are composed of elastic fibers. It has been found that such a thermal insulation filling material has excellent durability such as wash durability and compression resilience.

### BRIEF DESCRIPTION OF THE DRAWINGS

FIG. 1 is a photograph of the thermal insulation filling material of embodiment 1 of the present invention;

FIG. 2 is a test result of thickness and heat retention property of samples of respective embodiments and comparative examples of the present invention;

FIG. 3 is a test result of the thermal resistance retention rates of the samples of the respective embodiments and comparative examples of the present invention.

### DETAILED DESCRIPTION

In order to allow a person of skill in the art to better comprehend technical solutions of the present invention, the present invention is further described in detail below in combination with accompanying drawings and particular embodiments.

### Interpretation of Terms

In the present invention, the meanings of the following terms or descriptions are as follows:

The descriptions of “A to B” and “A˜B” include the value of A, the value of B, and any value greater than A and less than B.

“Fiber” refers to a continuous or discontinuous filament having a much greater dimension in the length direction than in any other directions in the cross section.

The “spherical fiber assemblies” refer to a substantially spherical structure formed by fiber winding, and is also referred to as a “fiber ball.”

“Denier (D)” is the unit for fiber fineness, which represents the weight in grams per 9000 meters of fibers at a given moisture regain. “gsm” is the unit of gram weight, expressed in grams per square meter; that is, the weight in grams per square meter of a sheet material.

“Clo” value is a parameter for evaluating the heat retention property of a material, which is actually a thermal resistance value. A greater thermal resistance value suggests a better heat retention property. When a person sitting quietly or engaged in slight brain work (a calorific value at 209.2 kJ/m²·h) feels comfortable in the environment with the temperature being 21° C., the relative humidity less than 50%, and wind speed not greater than 0.1 m/s, the Clo value of clothes worn is set as 1. Clo is further related to metric units by the relationship: 1 clo=6.457 m²° K./W.

### Thermal Insulation Filling Material

The present invention provides a thermal insulation filling material including spherical fiber assemblies composed of elastic fibers. The thermal insulation filling material of the present invention comprises includes fiber assemblies composed of elastic fibers; that is, the fibers forming the spherical fiber assemblies must be elastic fibers with strong elasticity.

Specifically, the elastic fibers have an elastic elongation of 80 to 300% and an elastic recovery of 85 to 99%. The elastic elongation and elastic recovery are calculated using the following formula: elastic extension (%)=100%×(L1−L0)/L0; elastic recovery (%)=100%×(L1−L2)/(L1−L0). In the test process, the initial load of 2 mg/d (mg per denier) is first hung on the fiber, then treated with hot water of 90° C. for 2 min, and then hung for 12 h, and the length measured after drying is L0; upon measurement of L0, the fixed load of 100 mg/d is hung thereon after removing the initial load for 2 min; and the length measured after 30 s is L1; upon measurement of L1, the initial load of 2 mg/d is reattached after removing the fixed load for 2 min; and the length measured after 30 s is L2.

In one embodiment, the elastic fibers have a three-dimensionally crimped structure; and the three-dimensionally crimped structure has a number of crimps of from 8 to 50/25 mm.

That is, the fibers for forming the above spherical fiber assemblies may be hollow, and may turn into a three-dimensionally crimped structure by themselves to form a spherical shape. More specifically, 8 to 50 crimps are formed in the fiber per 25 mm length (the number of crimps is obtained by dividing the total number of crimp peaks and crimp valleys by 2).

In one embodiment, the elastic fibers have a fineness of from 0.5 to 7 D and a length of from 15 to 75 mm; more preferably, the fineness is 2 to 6 D and the length is from 32 to 64 mm. In order to have the elastic fibers to form into desired spherical fiber assemblies, the size thereof is preferably within the above range.

In one embodiment, the elastic fibers comprise any one or more of a polyester fiber, a polyolefin fiber, a polyurethane fiber, a polylactic acid fiber, a polyether amide fiber, and a two-component composite fiber. Based on the materials, the elastic fibers may be classified into polyester fibers, polyolefin fibers, polyurethane fibers, polylactic acid fibers, or polyether amide fibers; or two-component composite fibers composed of two different materials such as polyester composite fibers (i.e., composite fibers of two different polyester materials), polypropylene/polyester composite fibers, polylactic acid composite fibers (i.e., composite fibers of two different polylactic acid materials).

In one embodiment, the spherical fiber assemblies have a particle size of from 2 to 20 mm. That is, the diameter (particle size) of each of the fiber balls (spherical fiber assemblies) in the thermal insulation filling materials shall be within the above range, so that the thermal insulation filling material can achieve better performances.

The thermal insulation filling material of the present invention mainly includes spherical fiber assemblies, and the spherical fiber assemblies are composed of elastic fibers. It has been found that such a thermal insulation filling material has excellent durability such as wash durability and compression resilience.

### Preparation Method of the Thermal Insulation Filling Material

The invention further provides a preparation method of the above thermal insulation filling material. The method includes balling the elastic fibers to form spherical fiber assemblies. That is, the raw elastic fibers can be subjected to a conventional spheronization process (other process like opening and loosening are also plausible) so as to form spherical fiber assemblies to obtain the above thermal insulation filling material.

### Thermal Insulation Article

The invention provides a thermal insulation article including a covering body and a thermal insulation filling material. The covering body defines an enclosed internal space and the thermal insulation filling material is disposed in the enclosed internal space defined by the covering body. That is, the above thermal insulation filling material can be disposed in the enclosed covering structure to form a practically applicable thermal insulation article.

In one embodiment, the covering body is a flexible covering body. That is, the above covering body can be a flexible material such as a fabric or a leather, so that it can form an enclosed internal space through processes like sewing. Thus, the thermal insulation article is flexible, and can be deformed to a certain extent according to the needs of the user, thereby providing a better user experience.

In one embodiment, the above thermal insulation article may be bedding articles, clothes, etc. Specific examples thereof include, but are not limited to, shoes, hats, clothes (including tops, pants, underwear, outwears, etc.), pillows, quilts, mats, sleeping bags, and the like.

### EMBODIMENTS

The specific embodiments of the present invention are described in more detail below.

### 1. Raw Materials

The details of the raw materials used in the embodiments and comparative examples of the present invention are as follows:

Elastic fiber 1: three-dimensional hollow siliconized elastic polyester fiber with a fineness of 2 D and a length of 32 mm, available from Unitika company, Japan.

Elastic fiber 2: three-dimensional hollow siliconized elastic polyester fiber with a fineness of 3 D and a length of 32 mm, available from Toray company, Japan.

Elastic fiber 3: three-dimensional hollow siliconized elastic polyester fiber with a fineness of 7 D and a length of 64 mm, available from Toray company, Japan.

Non-elastic fiber 1: a three-dimensional hollow siliconized polyester fiber with a fineness of 3D and a length of 32 mm, available from Sinopec Yizheng Chemical Fiber Co., Ltd., China.

Gray duck down: with down content of 80/20 (i.e., 80 wt % of duck down and 20 wt % of non-duck down substances such as feathers), available from down retail stores.

### 2. Performance Test Method

In order to evaluate the performance of the thermal insulation filling materials of the respective embodiments and comparative examples, a series of performance tests need to be conducted; and the specific test methods are as follows:

### 1) Sample Package Preparation

A 90-gram sample is sewn into a 12 in×12 in nylon cloth bag as a sample package 1. The sample of 200 gsm filling amount is blown into a 50 cm×50 cm nylon cloth bag; and five rectangular quilted cells of 10 cm×50 cm are sewn to obtain a sample package 2.

### 2) Thickness and Heat Retention Property

After the sample package 2 is vacuum-packed and left for 2 weeks, the package is opened and the article is placed for at least 24 hours without any pressure, and the following tests are performed:

the thickness of the sample package 2 is tested three times under a pressure of 20 Pa;

and the average value therefrom is used as the thickness of the sample package 2;

the Clo value is tested according to the ASTM F1868 Part C standard (i.e., GB/T 11048), including the following steps: the sample package 2 covers the test plate of area A; and the test plate is heated by the heating power H; after the temperature is stabilized, the temperature Tm of the surface of the test plate and the ambient temperature (air temperature) Ta are recorded; thermal resistance R is calculated, R=[A×(Tm−Ta)/(H−ΔH)]−R₀, where ΔH is the pre-measured heating power correction, and R₀ is the pre-measured thermal resistance correction; accordingly, a Clo value=6.451R is obtained.

### 3) Wash Durability

Sample Package 2 which has been tested for the Clo value is washed for 30 times per ISO6330 Han standard and then is placed in a tumbling dryer for 40 min; the Clo value is tested again and the thermal resistance retention rate (%)=100×(Clo value after washing)/(Clo value before washing) is calculated; FOM71 CLS horizontal drum-type washer (available from Electrolux) is adopted, with gentle mixing in each step.

### 4) Compression Resilience

The compression resilience of the sample is tested per ASTM D6571-01 (2001) standard, which specifically includes the following steps: placing Sample Package 1 on the chassis of thickness tester, applying 0.41 lb weight at the platen center according to the requirements of the above standard; and recording the initial thickness of Sample Package 1 as A; continuing to apply external weight to 16 lb on the sample according to the requirements of the above standard and the sample is placed for 24 h; changing the externally applied weight to 0.41 lb, waiting for 1 h and recording the thickness value C of Sample Package 1 after recovery; calculating the short-time compression resilience ratio (%): 100%×C/A.

### 3. Specific Embodiments and Comparative Examples

Using the above raw materials to prepare the thermal insulation filling materials for various embodiments and comparative examples. Details are as follows:

### Embodiment 1

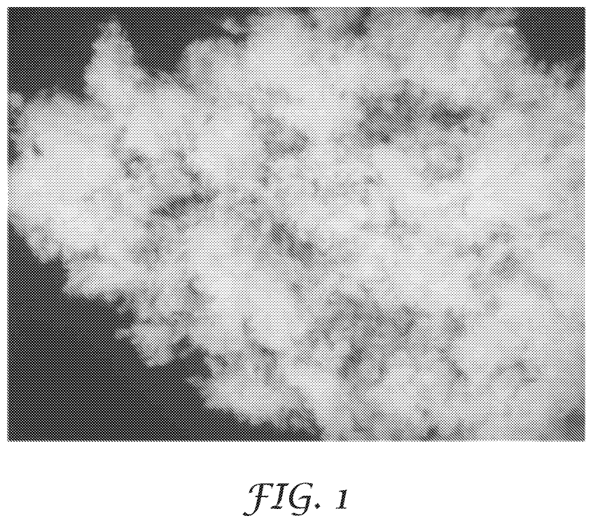

Take 5 kg of elastic fiber 1, fully open and use ball machine (HJZZM-100 ball fiber machine, available from Kunshan Haijin Machine Co., Ltd.) to form spherical fiber assemblies with a particle size of from 2 to 20 mm; the thermal insulation filling material of embodiment 1 is then obtained as shown in FIG. 1.

### Embodiment 2

Take 5 kg of elastic fiber 2, fully open and use ball machine (HJZZM-100 ball fiber machine, available from Kunshan Haijin Machine Co., Ltd.) to form spherical fiber assemblies with a particle size of from 2 to 20 mm; and the thermal insulation filling material of embodiment 2 is then obtained.

### Embodiment 3

Take 2.5 kg of elastic fiber 2 and of elastic fiber 3 respectively, fully open and mix; and use ball machine (HJZZM-100 ball fiber machine, available from Kunshan Haijin Machine Co., Ltd.) to form spherical fiber assemblies with a particle size of from 2 to 20 mm; the thermal insulation filling material of embodiment 3 is then obtained.

### Comparative Example 1

Take 5 kg of non-elastic fiber 1, fully open and use ball machine (HJZZM-100 ball fiber machine, available from Kunshan Haijin Machine Co., Ltd.) to form spherical fiber assemblies with a particle size of from 2 to 20 mm; the thermal insulation filling material of comparative example 1 is obtained.

### Comparative Example 2

Use gray duck down directly as the thermal insulation filling material of comparative example 2.

### 4. Results of Performance Test

The performance of the thermal insulation filling materials of all embodiments and comparative examples are tested according to the above performance test method; the specific results are as follows:

### 1) Thermal Insulation Performance

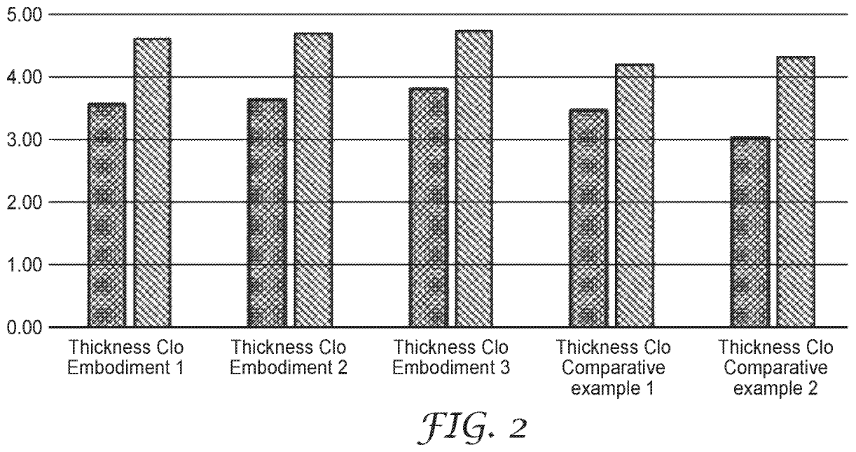

The thickness and heat retention property of all the samples of the embodiments and comparative examples were tested according to the above test methods; the results are shown in FIG. 2.

It can be seen that the thickness and heat retention property of the samples of embodiments are superior to those of samples of comparative examples, which indicates that the presence of elastic fibers in the thermal insulation filling material of the present invention results in greater fill power, thus saving more still air to provide better heat retention.

Therefore, the fill power and heat retention property of the filling material (before washing) in the invention are superior to those of non-elastic fiber sample (comparative example 1) or natural down sample (comparative example 2).

### 2) Wash Durability

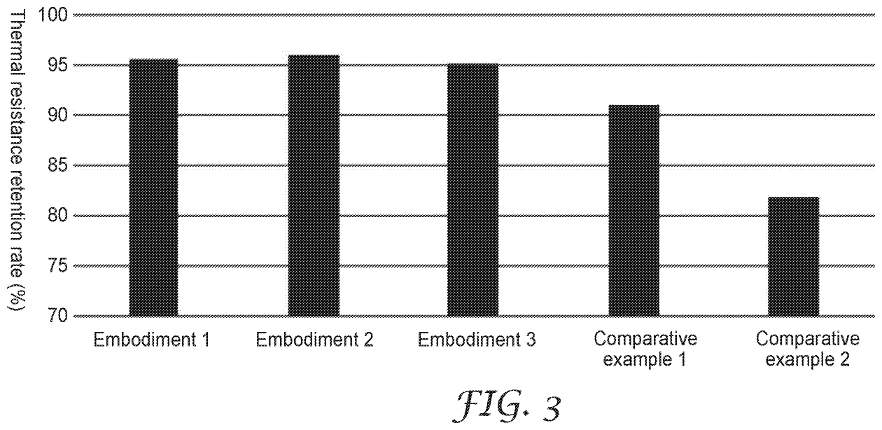

The thickness and heat retention property of all the samples of the embodiments and comparative examples were tested according to the above test methods; the results are shown in FIG. 3.

The results show that after washing, the thermal resistance retention rates of the samples of various embodiments are above 95%; the thermal resistance retention rates of the samples of comparative examples, on the other hand, only reach as high as about 90%, or just above 80%. The results above indicate that the thermal insulation filling material in the invention hardly changes its shape after being washed for many times; the fluffiness and uniform are still maintained, and thus the thermal insulation filling material does not have any obvious performance change. The existing thermal insulation filling material, on the other hand, appear to be evidently entangled after washing, therefore resulting in a significant performance degradation. Therefore, compared with the existing thermal insulation filling materials, the thermal insulation filling material of the invention has excellent wash durability.

### 3) Compression Resilience

The compression resilience of all the samples of the embodiments and comparative examples were tested according to the above test method; the results are shown in the table below.

TABLE 1
Short-term compression resilience of thermal insulation filling
materials of the embodiments and comparative examples

| Sample | Short-term compression resilience (%) |
|---|---|
| Embodiment 1 | 94.2 |
| Embodiment 2 | 94.9 |
| Embodiment 3 | 95.7 |
| Comparative example 1 | 83.4 |
| Comparative example 2 | 77.6 |

The results show that the compression resilience rates of the samples of each embodiment are at least 10% higher than those of the samples of the corresponding comparative examples. This indicates that the thermal insulation filling material of the present invention can rapidly restore to its original shape upon deformation; and its ability to maintain the original performance after being compressed (such as compressed and stored for a long time) is much robust than that of the existing thermal insulation filling material; additionally, the thermal insulation filling material of the present invention has better durability.

In conclusion, the thermal insulation filling material in the invention has good fill power and heat retention property that meet the requirements of thermal insulation filling material. After being washed for many times, the heat retention and other features of the thermal insulation filling material are kept unchanged, indicating that thermal insulation filling material is provided with excellent wash durability and its compression resilience is far better than that of the existing thermal insulation filling materials. Therefore, the thermal insulation filling material formed with spherical fiber assemblies using elastic fibers in the present invention are provided with good wash durability and compression resilience, which may replace the thermal insulation filling material like natural down in the prior art.

It can be understood that, the above embodiments are only exemplary embodiments employed for illustration of principles of the present invention, and do not limit the present invention. For those of ordinary skill in the art, various variations and modifications may be made without departing from the spirit and essence of the present invention, which variations and modifications are also considered as falling within the protection scope of the present invention.

1. A thermal insulation filling material, comprising:
spherical fiber assemblies composed of elastic fibers.

2. The thermal insulation filling material according to claim 1, wherein the elastic fibers have an elastic elongation of from about 80 to about 300% and an elastic recovery of from about 85 to about 99%.

3. The thermal insulation filling material according to claim 1, wherein the elastic fibers have a three-dimensionally crimped structure.

4. The thermal insulation filling material according to claim 3, wherein the three-dimensionally crimped structure has a number of crimps of from about 8 to about 50/25 mm.

5. The thermal insulation filling material according to claim 1, wherein the elastic fibers have a fineness of from about 0.5 to about 7D.

6. The thermal insulation filling material according to claim 1, wherein the elastic fibers have a length of from about 15 to about 75 mm.

7. The thermal insulation filling material according to claim 1, wherein the elastic fibers comprise any one or more of a polyester fiber, a polyolefin fiber, a polyurethane fiber, a polylactic acid fiber, a polyether amide fiber, and a two-component composite fiber.

8. The thermal insulation filling material according to claim 1, wherein the spherical fiber assemblies have a particle size of from about 2 to about 20 mm.

9. A method for preparing a thermal insulation filling material, wherein the thermal insulation filling material is the thermal insulation filling material according to claim 1, the preparation method comprising:
balling the elastic fibers to form the spherical fiber assemblies.

10. A thermal insulation article, comprising:
a covering body, the covering body defining an enclosed internal space;
a thermal insulation filling material filled in the enclosed internal space defined by the covering body; the thermal insulation filling material being the thermal insulation filling material according to claim 1.

11. The thermal insulation article according to claim 10, wherein the covering body is a flexible covering body.

12. The thermal insulation article according to claim 10, wherein the thermal insulation article is any one of shoes, hats, clothes, pillows, quilts, mats, and sleeping bags.
